(19) United States
(12) Patent Application Publication
(10) Pub. No.: US 2004/0228417 A1
(43) Pub. Date: Nov. 18, 2004

(54) Communication system with adaptive channel correction

(75) Inventors: Levi Kennedy, Cary, NC (US); Paul Robert Runkle, Durham, NC (US); Brett Dean Bradford Guenther, Apex, NC (US)

Correspondence Address: McDERMOTT, WILL & EMERY, 600 13th Street, N.W., Washington, DC, 20005-3096, US

(73) Assignee: MCNC Research and Development Institute

(21) Appl. No.: 10/435,047

(22) Filed: May 12, 2003

(51) Int. Cl. H04K 1/10; H04L 27/28; H04B 1/10

(52) U.S. Cl. 375/260; 375/350

(57) ABSTRACT

Adaptive methods and systems for applying a channel correction factor to received signals to correct errors caused by channel distortion. The channel correction factor is dynamically calculated and updated based on the received signal or signals. A receiver continuously calculates an error factor representing a deviation of the received signal from the signal being transmitted, and generates the channel correction factor based on the error factor. Since the error factor includes information related to channel distortions, the channel correction factor so calculated adapts to the change of channel characteristics. If preferred, an advanced algorithm can be used to predict the channel response for the next incoming signal such that the receiver can correct channel errors on a substantially real-time basis.

### FIELD OF THE DISCLOSURE

The present disclosure generally relates to communication methods and systems using adaptive channel estimation and error removal, and more specifically, to communication systems that track changes in channel conditions and adaptively adjust an amount of compensation applied to incoming signals based on the changes in channel conditions.

### BACKGROUND OF THE DISCLOSURE

Signals transmitted by a wireless communication system are subject to noise and channel distortion. Thus, when the signals are received by a receiver of the wireless communication system, the receiver needs to consider the distortion and noise in order to obtain correct signals.

A receiver in a wireless communication system typically includes an equalizer to estimate channel response and variance, and to compensate for errors caused by the channel through which signals are transmitted. FIG. 1 depicts a conventional receiver of an Orthogonal Frequency Division Multiplexing (OFDM) system. OFDM is a multi-carrier transmission technique, which divides available spectra into many narrow-band sub-channels. Signals are transmitted in each sub-channel in parallel. The OFDM receiver includes an antenna 10, an RF receiver 12, a fast Fourier transform (FFT) module 14, an equalizer 16 and a decision module 18.

After antenna 10 receives OFDM signals sent from an OFDM transmitter (not shown), RF receiver 12 performs a receiving process of the OFDM signals including checking the type of the signal. The OFDM signals are then passed through FFT module 14, which converts the OFDM signals to the frequency domain. Equalizer 16 receives the output of FFT module 14, and is used to compensate for channel distortions caused by the channel through which the signals are transmitted. The OFDM signals are then sent to decision module 18 that demodulates the OFDM signals and conducts signal processing to determine contents of the OFDM signals.

In order to properly compensate for the channel distortion, equalizer 16 needs to know the amount of distortion caused by the transmission channel so that proper compensation can be applied to the signals received from that channel. One way to determine the channel distortion is to transmit a reference signal from the transmitter to the receiver, wherein the reference signal is known to the receiver. The receiver then compares the transmitted reference signal, which is received and processed by the receiver, with the known reference signal to determine the channel response. The amount of channel distortion can then be determined based on the error between the transmitted reference signal and the known reference signal. Equalizer 16 can then apply a fixed channel correction factor, such as an inverse response equation corresponding to the channel distortion, to the received signals to compensate for or offset the channel distortion.

However, using a fixed channel correction factor to compensate for the channel distortion has drawbacks. When the channel response is time varying or unstable, the amount of channel distortion varies. In such a circumstance, applying a fixed channel correction factor to the received signal can no longer compensate for the channel distortion properly.

Some other problems exist in wireless communication systems. Wireless networks, such as IEEE 802.11a networks, may use medium access control (MAC) layer protocols that have a distributed coordination function (DCF) based on a carrier sense multiple access (CSMA) collision avoidance (CA) rules, which require all stations wanting to send a frame to listen to the channel prior to transmission. If the transmitter senses energy exceeding a certain threshold, the station will wait until the medium is idle before transmitting. If an intentional (e.g. denial of service attack) or unintentional (e.g. hidden node) jammer is present, the communication between the stations is halted because the stations falsely believe that the channel is occupied by other users.

In order to resolve this problem, conventionally, a MAC layer may employ an alternate access method for coordination of transmitters. A virtual carrier sense mode may be used for long packets (longer than a threshold value set by the administrator). In this mode, no actual physical sensing of the medium occurs. Instead, information about the use of the medium is exchanged through the use of control frames. This approach reduces the possibility of collisions between hidden nodes, but reduces the overall throughput resulting from the exchange of control frames, and adds complexity to handshaking.

Another conventional approach to resolve the problem is using synchronous timing for access to the medium. The MAC layer may employ point coordination function (PCF) to impose timing requirements on the stations so that each station has a contention-free access to the medium.

These conventional approaches attempt to minimize the effects of jamming through sensing, scheduling and acknowledgements, but fail to correct errors from a physical level, such as correcting errors caused by channel distortion. In addition, these approaches need to be configured offline by a network administrator. Furthermore, if an access point (AP) cannot “hear” the clients over the jamming (or vice versa), then the system fails and network service is brought to a halt.

Therefore, there is a need to provide a channel correction that dynamically corrects or compensate for channel distortions based on the channel transmission quality. There is another need for an equalizer that is adaptive to fast decaying channels. There is also a need to improve the performance of a communication system by configuring a communication system based on performance of transmission channels.

### SUMMARY OF THE DISCLOSURE

The concepts disclosed herein address the above noted needs as well as other needs and problems. More specifically, an adaptive receiver and advanced signal processing are described to dynamically compensate for errors and/or distortions caused by the transmission channel. The amount of compensation applied by the receiver varies with the quality of the transmission channel such that the channel errors are properly offset by the receiver even if the characteristics of the transmission channel change over time.

An exemplary adaptive receiver in accordance with the present disclosure includes an adaptive equalizer that applies a channel correction factor to the received signals to correct errors and/or distortions caused by the transmission channel. The channel correction factor is dynamically calculated and updated based on received signal or signals. For instance, the receiver continuously calculates an error factor representing a deviation of the received signal from the signal being transmitted, and generates the channel correction factor based on the error factor. Since the error factor includes information related to channel distortions, the channel correction factor so calculated adapts to the change of channel characteristics.

In one aspect, the adaptive receiver applies the channel correction factor to the received signals in the frequency domain. In another aspect, the adaptive receiver is implemented as an OFDM receiver, in which multiple sub-carriers are used to transmit signals. The receiver independently applies the channel correction factor to each sub-carrier so that the different channel characteristics affecting each of the sub-carriers in the transmission channel are properly compensated. If preferred, an advanced algorithm can be used to predict the channel response for the next incoming signal such that the receiver can timely correct the channel distortions without delay.

An exemplary method for processing the received signals and updating the channel correction factor utilizes a feedback loop to determine channel distortion and to determine the amount of compensation. A corrected signal is generated by applying a channel correction factor to a received signal. The corrected signal is then processed to generate a decoded signal to extract the signal content. The channel correction factor can be calculated and updated by comparing the error between the decoded signal and the received signal or the corrected signal. The steps are continuously performed such that the channel correction factor adapts to the changes in the transmission channel.

An adaptive receiver using a predictive algorithm is also disclosed. The receiver predicts the channel response for the received signal by using advanced mathematical algorithms and previously received signal or signals. A predictive channel correction factor is generated to correct channel distortion and/or errors. The performance of the predictive channel correction factor is closely monitored. For example, the receiver calculates an error vector between the decoded signal and the corrected signal, or between the decoded signal and the received signal. If the error exceeds a predetermined threshold, it implies the predictive channel correction factor cannot effectively compensate for the changes in the transmission channel. In response, the receiver applies another mathematical algorithm to calculate the predictive channel correction factor until the factor can effectively offset the errors caused by the transmission channel.

In one aspect, the equalizer applies the channel correction factor to incoming signals dynamically, depending on the transmission quality. If transmission quality is good and stable, the equalizer may apply the channel correction factor to incoming signals less frequently, such as once every several symbols. On the other hand, if the transmission quality varies with time, the equalizer may apply the channel correction factor to the incoming signals more frequently, such as to every symbol.

An advanced communication system is also described which utilizes information related to channel distortions to control signal transmissions. For example, the system has a controller that receives a signal generated by the receiver that represents a deviation of the received signal from the signal being transmitted. If such a signal indicates that the transmission quality of a specific transmission channel is not acceptable, the controller commands the system to stop using the transmission channel to transmit signals, and switch to another channel that has better transmission quality, so that a better overall transmission quality can be achieved without involving additional error corrections and calculations.

Additional aspects and advantages of the present disclosure will become readily apparent to those skilled in this art from the following detailed description, wherein only exemplary embodiments of the present disclosure is shown and described, simply by way of illustration of the best mode contemplated for carrying out the present disclosure. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawings and in which like reference numerals refer to similar elements and in which:

FIG. 1 is a block diagram of a conventional OFDM receiver.

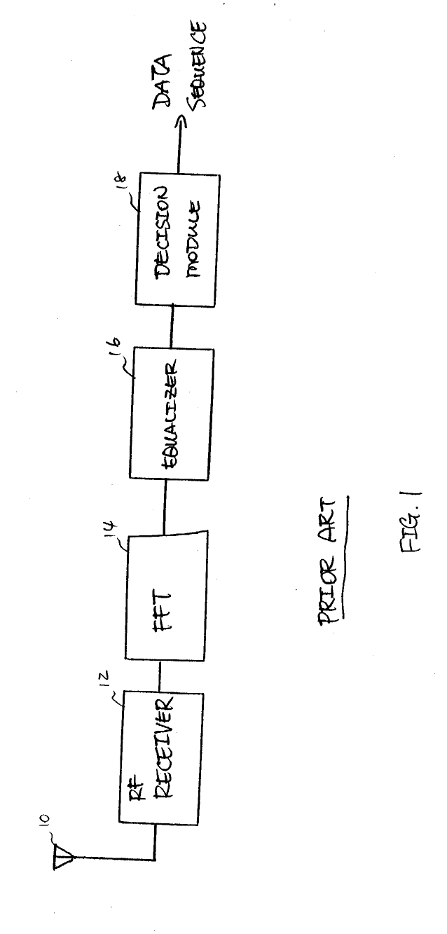

FIG. 2a shows a signal frame structure under the IEEE 802.11a standard.

FIG. 2b shows an exemplary constellation used in determining the signal being transmitted.

FIG. 3 depicts an exemplary OFDM receiver with adaptive channel correction.

FIG. 4 is a flow chart showing the operation of the OFDM receiver illustrated in FIG. 3.

FIG. 5 shows a second embodiment of an OFDM receiver with adaptive channel correction.

FIG. 6 depicts an exemplary OFDM receiver using predictive algorithm to predict channel responses to achieve adaptive channel correction.

FIG. 7 is a flow chart illustrating the operation of the receiver described in FIG. 6.

FIG. 8 shows another embodiment of an OFDM receiver using adaptive channel correction.

### DETAILED DESCRIPTION OF THE DISCLOSURE

In the following description, for the purposes of explanation, numerous specific details are set forth in order to provide a thorough understanding of the present disclosure. It will be apparent, however, to one skilled in the art that the present disclosure may be practiced without these specific details. In other instances, well-known structures and devices are shown in block diagram form in order to avoid unnecessarily obscuring the present disclosure.

The following examples are described with reference to OFDM and IEEE 802.11a standard. It is noted that the use of OFDM and IEEE 802.11a standard is for illustration purpose only. The same concepts can be applied to other coding and modulation techniques as well as other communication protocols that are known to peopled skilled in the art.

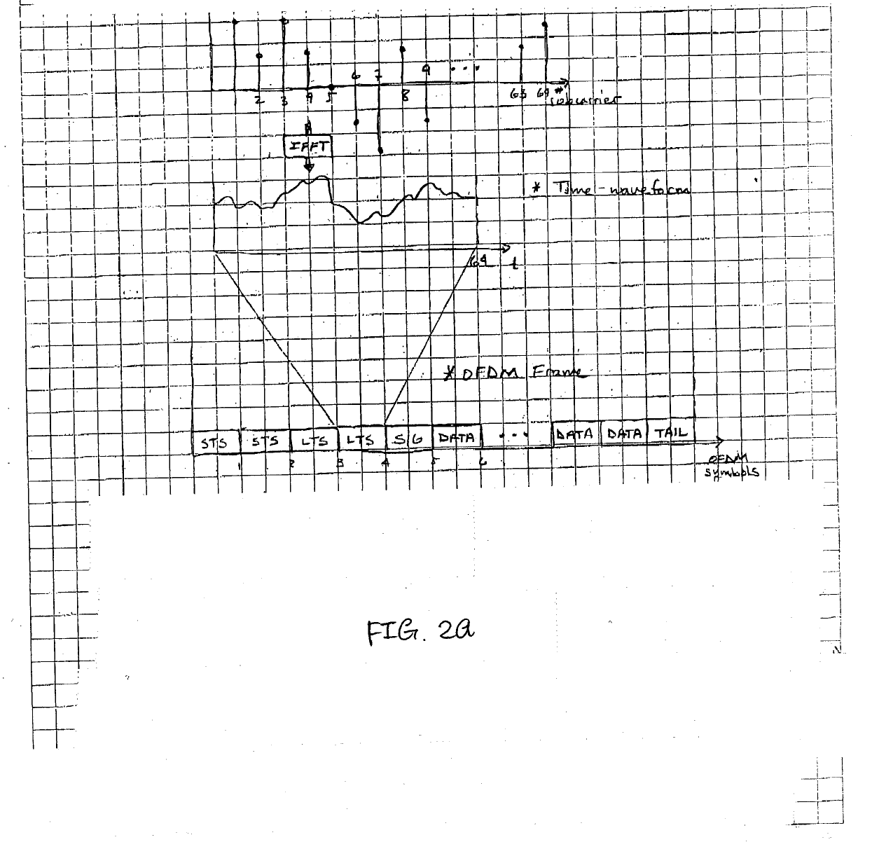

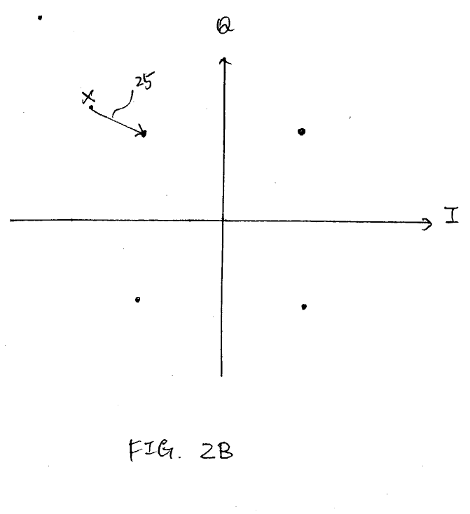

OFDM is used in many industrial and communication standards, such as IEEE 802.11a standard. Under the IEEE 802.11 a standard, digital data are grouped and transmitted in signal frames. FIG. 2a shows a signal frame structure in accordance with the IEEE 802.11a standard. Each signal frame includes a plurality of symbols. Each symbol is composed of 52 sub-carriers and 12 zero spaces. There are various types of symbols in each frame. The first type is Short Training Sequence (STS) symbol that is used for frequency and timing synchronization. The second type of symbol is a Long Training Symbol (LTS) that is used for channel estimation in conjunction with equalizers. The third type of symbol is a SIG (Signal Field) symbol that contains information about transmission rates, forward error correction parameters and frame length. The fourth type of symbol is a Data symbol that contains data, and the fifth type is a Tail symbol to reset state machines.

As discussed earlier, OFDM is a multiple-carrier transmission technique that divides the available spectrum into many narrow-band sub-channels. In OFDM systems, digital data are mapped onto a modulation mapped signal, or one point in a designated signal constellation. Each modulation mapped signal from a constellation is used as one point of an inverse fast Fourier transform to produce time domain waveforms that include information related to the digital data. The time domain waveforms are then transmitted through a physical channel. Due to multi-path fading, Doppler spread, and/or receiver thermal noise, the waveforms received by an OFDM receiver contain channel distortion errors.

After the signal is received by the receiver, the receiver converts the signal to the frequency domain and maps the signal in a designated symbol constellation to determine what the signal represents. FIG. 2b shows an exemplary constellation having a quadrant with four constellation points. Other numbers of constellation points can be used depending on system designs. The receiver maps the received signal in the constellation and determines which is the closest constellation point based on the Euclidean distance between the signal and the constellation point. The receiver then decides that the nearest constellation point is the position that the signal is expected to be.

### Adaptive Channel Correction

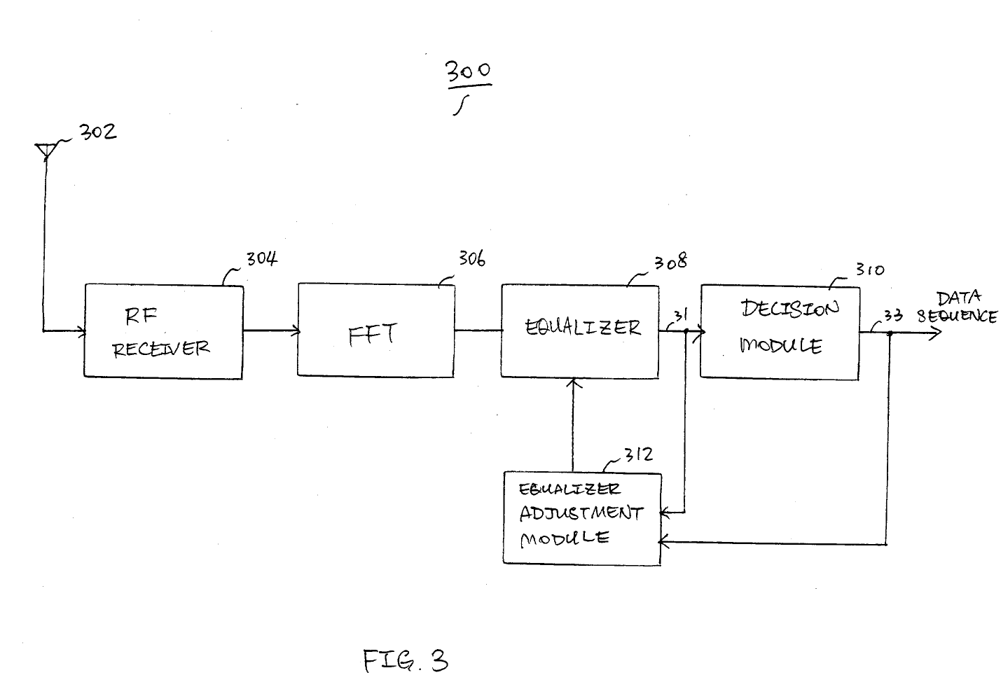

FIG. 3 depicts an exemplary OFDM receiver 300 with adaptive channel correction in accordance with the present disclosure, which can be utilized, for example, with the IEEE 802.11a standard. The receiver 300 calculates the channel response for an incoming signal and determines an error caused by the transmission channel. The receiver 300 then calculates a channel correction factor with the effect to compensate for the amount of error caused by channel distortion. The receiver 300 applies the error correction factor to the next incoming signal. The same process is repeated for each incoming signal. As a result, the channel correction factor is updated every time when a new signal arrives at the receiver 300. Since the error correction factor is calculated and updated dynamically based on the most recent incoming signal, the error correction factor is able to trace the amount of distortion even when the channel characteristics are unstable or time-varying.

Referring to FIG. 3, receiver 300 includes antenna 302, RF receiver 304, FFT module 306, equalizer 308, decision module 310 and equalizer adjustment module 312. After antenna 302 receives a signal sent from an OFDM transmitter (not shown), RF receiver 304 processes the received signal, and performs functions including checking the type of the received symbol or signal.

The received signal is then passed through FFT module 306, which converts the received signals to the frequency domain. Equalizer 308, which is coupled to the output of FFT module 306, generates a corrected signal 31 by applying a channel correction factor to the received signals in the frequency domain to compensate for channel distortions caused by the transmission channel through which the signals are transmitted. Corrected signal 31 is then sent to decision module 316. Decision module 316 processes frequency domain signals and extracts signal contents therefreom. For example, decision module 316 may demodulate and process the corrected signal 31 to determine and/or extract the signal contents. Decision module 316 then generates a decoded signal 33 that may be in the form of a digital data sequence.

In order to extract signal contents from the corrected signal 31, as discussed in conjunction with FIG. 2b, decision module 310 may map the received signal in the constellation and determine which is the closest constellation point based on the Euclidean distance between the signal and the constellation point. Decision module 310 then decides that the nearest constellation point is the position that the signal is expected to be. Decision module 310 then outputs the nearest constellation point as decoded signal 33.

The receiver 300 uses an equalizer adjustment module 312 to adjust the amount of compensation applied by the equalizer. The amount of adjustment is determined based on the amount error caused by channel distortion. In order to determine the amount of adjustment, the equalizer adjustment module 312 may utilize an error factor that represents a deviation of a signal received by the receiver from a signal being transmitted by a transmitter. For example, the error factor may be the error vector shown in FIG. 2b, which represents the error between the mapped signal x and the nearest constellation point.

As the received signal is affected by channel distortion and/or errors when passing through the transmission channel, the received signal includes information of the effects of the transmission channel. Therefore, when equalizer adjustment module 312 calculates an error factor, such as the error vector 25, based on decoded signal 33 and corrected signal 31, the error factor includes information of the most recent channel characteristics.

In order to calculate the error factor, the equalizer adjustment module 312 may modulates the decoded signal 33 and computes the error between the corrected signal 31 and the modulated decoded signal. In another embodiment, the decision module 310 may calculate an error vector while generating the decoded signal 33 from corrected signal 31. The error vector is then sent to the equalizer adjustment module 312 for further process. If the equalizer adjustment module 312 receives the error factor from the decision module 310, the equalizer adjustment module 312 does not have to receive signal inputs 31 and 33 because the error factor is already provided by the decision module 310.

The equalizer adjustment module 312 calculates a channel correction factor, which represents the amount of compensation, based on the error factor. Detailed process for calculating the channel correction will be described shortly. After the amount of channel correction is calculated, the equalizer adjustment module 312 updates the channel correction factor and controls equalizer 308 to apply the most updated channel correction factor such that the most recent channel variation is taken into consideration during channel correction. Consequently, the receiver 300 is adaptive to changes in the transmission channel and effectively compensates for the errors and/or distortions caused by thereby.

Equalizer 308 may apply the updated channel correction factor to the next signal or any signal received after the signal from which the most updated channel correction factor is generated. In one embodiment, equalizer 308 applies the channel correction factor at a specific frequency, such as one in every several symbols. In another embodiment, equalizer 308 may apply the channel correction factor at a varying frequency, depending on the transmission quality. For example, if the transmission quality is poor, equalizer applies the channel correction factor more frequently, such as to every symbol. On the other hand, if the channel transmission quality is good, equalizer may apply the channel correction factor less frequently. The transmission quality can be determined based on the error factor.

OFDM receiver 300 calculates an initial value of the channel correction factor based on training symbols. The number of training symbols used in determining the initial value of the channel correction factor depends on the specific communication protocol being utilized by the OFDM receiver. As described earlier, under the IEEE 802.11a standard, each signal frame includes two long training symbols (LTS). The LTS are known to the OFDM receiver 300. For example, prior to receiving any signal, the information related to the LTS may be pre-stored in a memory device accessible by the OFDM receiver 300.

When antenna 302 receives the training symbols transmitted from the transmitter, RF receiver 304 recognizes the symbols as LTS. Equalizer adjustment module 312 then determines channel distortion by comparing the received LTS and the LTS known to the OFDM receiver 300 to determine an error factor that represents the amount of distortion caused by the transmission channel. Equalizer adjustment module 312 calculates an initial value of the channel correction factor based on the response of the LTS. Details of calculating the initial value of the channel correction factor is described as follows.

An initial value of channel correction factor is set to be the amount to compensate for the error caused by channel distortion when the training symbols passing through the channel. The channel response for the training symbols can be calculated as follows:

Ĉ(k)=Ĉₖe^{j\hat{φ}}^{C}^{ₖ} k=1 . . . N

$${\hat{C}}_{k} = \frac{\vert {R}_{TS} ( k ) \vert}{\vert {I}_{TS} ( k ) \vert} \qquad {\hat{φ}}_{{C}_{k}} = {φ}_{{R}_{TS}} - {φ}_{{I}_{TS}}$$

wherein

Ĉ(k)=Estimated Channel response

R_{TS}(k)—Received training symbol

I_{TS}(k)—Actual training symbol known to receiver

k=sub-carrier index

N=Number of sub-carriers

Thus, an estimated channel response for each sub-carrier is determined. Accordingly, the initial value of the channel correction factor, which is the amount needed to compensate for the error caused by the channel distortion, is known. In one example, the initial value of the channel correction factor can be set as an inverse equation of the estimated channel response to offset the error caused by channel distortion.

In one embodiment, noise variance added to the signals by the transmission channel is also taken into consideration when calculating the channel correction factor. The noise variance of the transmission channel can also be obtained based on responses of training symbols. As the information contained in the training symbols are identical and the channel distortions are substantially the same, noise estimates can be obtained by subtracting one training symbol response from the other:

R_{TS1}(k)=S_{TS}(k)C(k)+nₓ_{₁}

R_{TS2}(k)=S_{TS}(k)C(k)+n_{X}_{₂}

$$\begin{matrix}{R}_{TS 1} - {R}_{TS 2} = {S}_{TS} ( k ) C ( k ) - {S}_{TS} ( k ) C ( k ) + {n}_{{x}_{1}} - {n}_{{x}_{2}} \\ = {n}_{{x}_{1}} - {n}_{{x}_{2}} \\ = {\hat{n}}_{x}\end{matrix}$$

wherein

R_{TS1}(k)=Received OFDM training symbol after FFT

S_{TS}=Send OFDM training symbol after FFT

nₖ=Additive noise

The responses of the training symbols cancelled out each other because the contents of two training symbols are the same.

Thus, the noise variance is:

$${σ}_{n}^{2} = \frac{var ( Re \{ {\hat{n}}_{k} \} ) + var ( Im \{ {\hat{n}}_{k} \} )}{4}$$

Accordingly, equalizer adjustment module 312 calculates and sets the initial magnitude channel correction factor as:

$${H}_{k} = \frac{1}{\sqrt{{C}_{k}^{2} + {σ}_{n}^{2}}}$$

wherein Hₖ=Magnitude of channel correction

Channel correction factor to compensate for phase errors is \hat{φ}_{C}_{ₖ}=φ_{R}_{_{TS}}−φ_{I}_{_{TS}}.

After the initial value of the channel correction factor is determined, equalizer 308 applies the channel correction factor to the next OFDM symbol to obtain a corrected symbol:

R(k)=RₖHₖe^{j(φ}^{-φ}^{_{ck}}⁾ k=1 . . . N

wherein

R(k)=Corrected signal for each sub-carrier

Rₖ=Magnitude of uncorrected signal for each sub-carrier

After the corrected symbol is obtained, decision module 310 decodes the corrected signal to generate a decoded signal. Decision module 310 may be a standard demodulation block that maps each corrected signal to its nearest constellation point using a process discussed relative to FIG. 2b.

After decision module 310 generates the decoded signal 33, equalizer adjustment module 312 calculates an error factor that represents an amount of error between the corrected signal 31 and the decoded signal 33. The calculation of the error factor can be carried out in the same way as calculating the error between the received LTS and known LTS as described earlier:

D(k)=Dₖe^{jφ}^{_{Dk}}, wherein D(k) is the corrected signal

ε(k)=εₖe^{jφ}^{_{Ek}}, wherein E(k) is the error factor

wherein:

$${ϵ}_{k} = \frac{{R}_{k}}{{D}_{k}} \qquad {φ}_{Ek} = {φ}_{Rk} - {φ}_{Dk}$$

Equalizer adjustment module 312 then updates the channel correction factor based on the error factor. Equalizer 308 then applies the updated channel correction factor to the next data symbol as follows:

Cₖ[n]=αNₖ[n]+(1−α)Cₖ[n−1]

wherein

Nₖ[n]=Cₖ[n−1]εₖ[n]

Cₖ[n] is the new channel response and Cₖ[n−1] is the old channel response; and the parameter a is a weighting factor that determines the amount of emphasis given to a channel estimate. Receiver 300 repeats the process for each OFDM symbol in the frame.

For an ideal channel, there would be no noise and the value of α should be set to 1. However, in reality, noise exists and therefore the new channel estimate will have a combination of channel variation and noise. By decreasing a, the effect is to lower the effects of the noise on the new channel estimate. The price for doing this is that the channel variations can not be tracked quickly. The higher the noise, the lower the value of a should be, and the greater the decrease in channel variation can be reliably tracked.

The factor α can be obtained in various different ways. For instance, a can be set empirically. The range of high and low a is small. It is atypical that α is above 0.5 or below 0.2. Therefore, a can be set at 0.3. α may also be set based on probability of errors. The probability of error might indicate an increase in the channel variation. α may also be set based on the SNR of the received signal. The value of a is adjusted according to the SNR. For example, high a for large SNR and low a for small SNR.

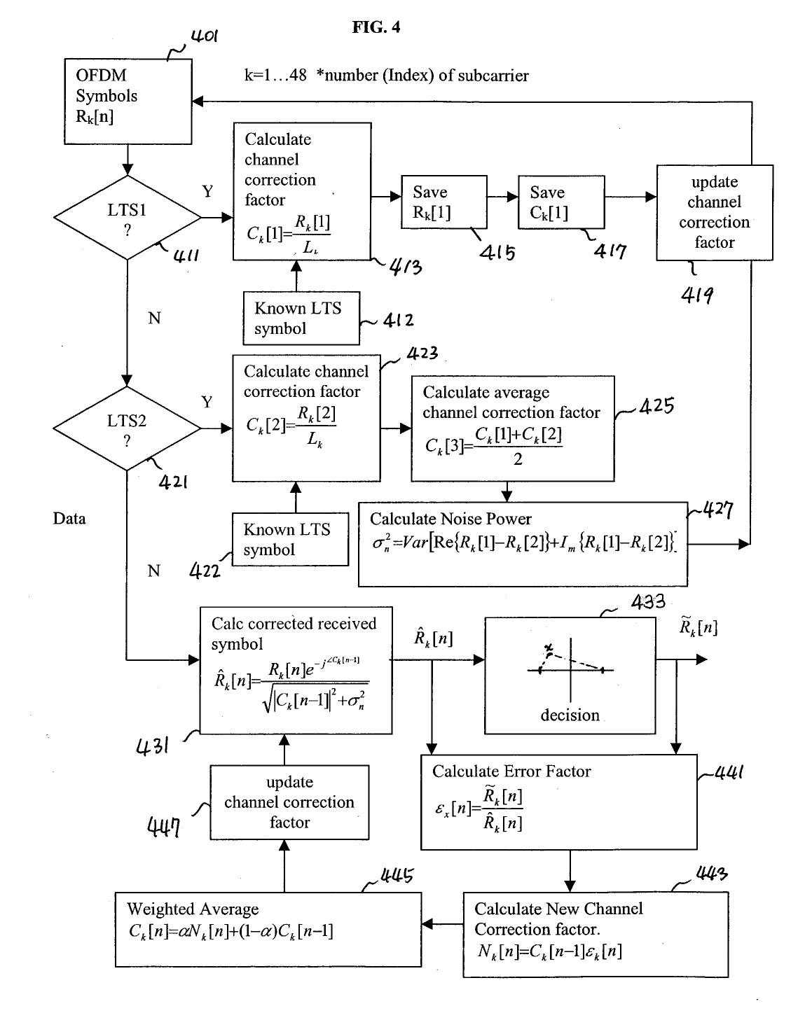

FIG. 4 is a flow chart illustrating the operation of OFDM receiver 300 shown in FIG. 3. In step 401, receiver 300 receives OFDM symbols. In steps 411 and 421, receiver 300 determines whether the received symbol is LTS. If the received symbol is the first LTS, the symbol is converted to the frequency domain by FFT module 306, and equalizer adjustment module 312 calculates a channel response of the first LTS (steps 413, 415, 417) based on the LTS symbol known to the receiver (block 412).

If the received symbol is the second LTS, the symbol is converted to the frequency domain by FFT module 306, and equalizer adjustment module 312 calculates a channel response for the second LTS (step 423) based on the second LTS symbol known to the receiver (block 422). Equalizer adjustment module 312 further calculates an average channel response and noise power based on the channel response for the first LTS and the second LTS (steps 425 and 427). Equalizer adjustment module 312 then calculates an initial value for the channel correction factor as discussed earlier, and updates the channel correction factor. Equalizer 308 applies the channel correction factor to the next symbol (step 429).

If the received symbol is not an LTS, equalizer 308 applies the channel correction factor to the symbol to generate a corrected symbol (step 431). The corrected symbol is then passed through decision module 310 which generates a decoded symbol (step 433). Equalizer adjustment module 312 then calculates an error factor (step 441) and a new channel correction factor (steps 443 and 445). In step 447, equalizer adjustment module 312 updates the channel correction factor. Equalizer 308 applies the channel correction factor to the next symbol (step 447).

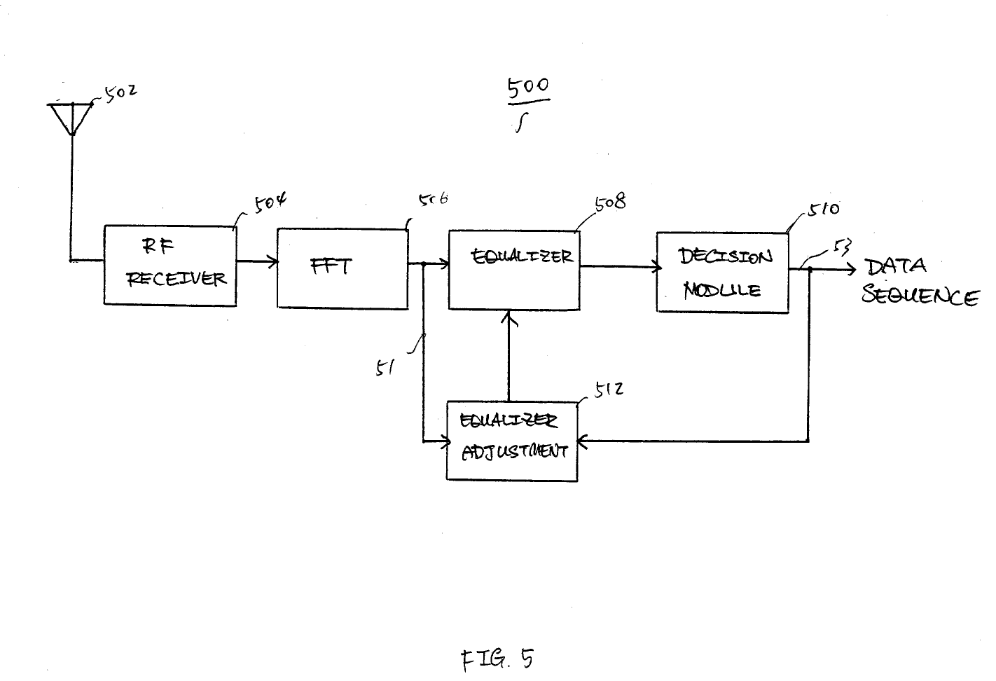

FIG. 5 shows a second embodiment of an OFDM receiver with adaptive channel correction, which is a variation of the OFDM receiver 300 shown in FIG. 3. OFDM receiver 500 includes antenna 502, RF receiver 504, FFT module 506, equalizer 508, decision module 510 and equalizer adjustment module 512.

In FIG. 5, equalizer adjustment module 512 receives inputs from FFT module 506 and decision module 510. Thus, equalizer adjustment module 512 calculates an error factor that represents an amount of error between uncorrected signal 51 and decoded signal 53, instead of an error between the corrected signal and the decoded signal. Other operations of OFDM receiver 500 are comparable to those of the OFDM receiver 300 shown in FIG. 3.

The calculation of the error factor can be carried out in the same way as calculating the error between the received LTS and known LTS as described earlier:

D(k)=Dₖe^{jφ}^{_{Dk}}, wherein D(k) is the corrected signal

ε(k)=εₖe^{jφ}^{_{Ek}}, wherein ε(k) is the error factor

wherein:

$${ϵ}_{k} = \frac{{R}_{k}}{{D}_{k}} \qquad {φ}_{Dk} = {φ}_{Rk} - {φ}_{Dk}$$

Based on the error factor, equalizer adjustment module 512 calculates an updated channel correction factor. Equalizer adjustment module 512 then updates the channel correction factor based on the error factor. Equalizer 508 then applies the updated channel correction factor to the next data symbol as follows:

C(k)_{new}=αε(k)+(1−α)C(k)_{old}

wherein C(k)_{new} is the new channel response and C(k)_{old} is the old channel response; and the parameter α is a weighting parameter that can be adjusted to affect the rate of convergence of the channel correction and the effects of high noise on the correction. The parameter a is chosen depending on the SNR of the received signal and has the effect of averaging the noise.

Equalizer 508 then applies the updated channel correction factor to the next symbol. Other operations of other blocks of OFDM receiver 500 are substantially the same as that described in connection with OFDM receiver 300, only the interconnections and values of parameters are different due to the different error factor calculation.

In the OFDM receivers described above, the receivers use a channel correction factor derived from previous symbols to correct channel distortions of an incoming symbol. Therefore, the channel correction as described is at least one symbol delayed. Such correction is effective when the channel variation is insignificant between symbol to symbol. However, for transmission channels that are fast fading, new approaches are required to properly correct for rapid channel variations. The following embodiments show exemplary OFDM receivers that utilizes predictive algorithm to predict channel responses for incoming symbols, such that the channel correction factor can effectively compensate for channel errors on a substantially real-time basis.

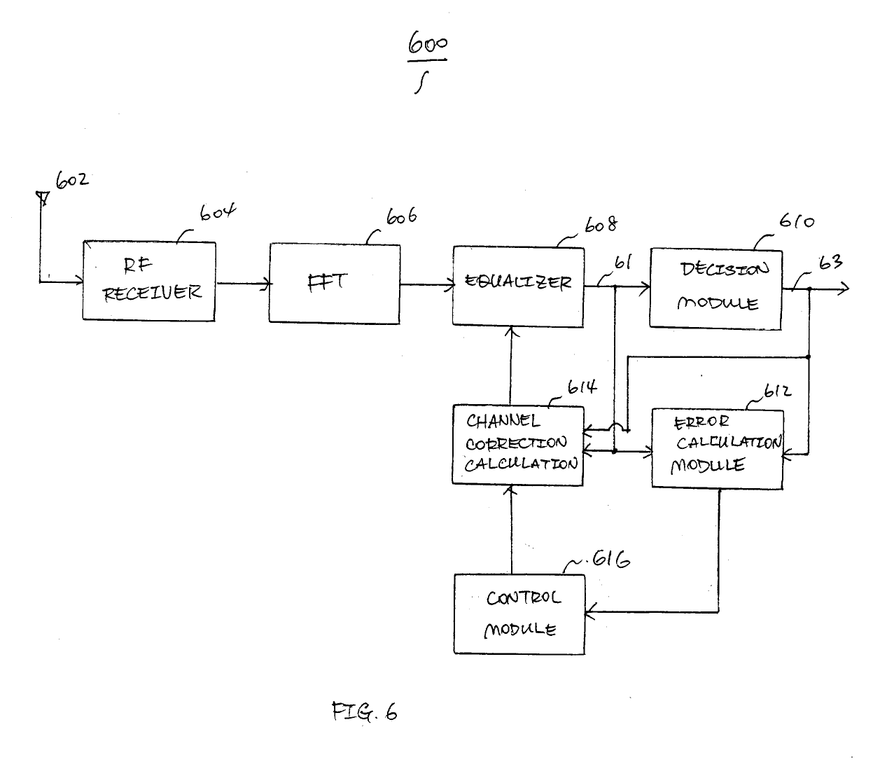

FIG. 6 shows an OFDM receiver 600 that can be utilized with the IEEE 802.11a standard. The receiver 600 includes antenna 602, RF receiver 604, FFT module 606, equalizer 608, decision module 610, error calculation module 612, control module 614 and channel correction calculation module 612.

After antenna 602 receives signals sent from an OFDM transmitter (not shown), RF receiver 604 performs a receiving process of the signals including checking types of the symbols received by the receiver. The received signals are then passed through FFT module 606, which converts the received signals to the frequency domain. Similar to the process described relative to FIG. 3, equalizer 608 generates a corrected signal 61 by applying a channel correction factor to the received signals to compensate for errors caused by the transmission channel through which the signals are transmitted. Corrected signal 61 is then sent to decision module 610. Equalizer 608 is also used to calculate channel responses using training signals and/or symbols as discussed earlier.

Decision module 610 decodes the corrected signal 61 to generate a decoded signal 63. As stated previously, decision module 610 may be a standard demodulation block that maps each corrected signal in the received symbol to its nearest constellation point as described with respect to FIG. 2 and FIG. 3. The output of the decision module 610 may be in a form of digital data sequence.

Channel correction calculation module 614 is used to generate a channel correction factor to correct channel distortions. Channel correction calculation module 614 is coupled to equalizer 608 and decision module 610, and receives corrected signal 61 and decoded signal 63 as input signals. Channel correction calculation module 614 uses statistical algorithms to predict the channel response. Examples of algorithms that can be used to predict the channel response include Levinson-Durbin algorithm, Kalman, LMS, etc.

Error calculation module 612 is used to generate an error factor 65 that represents a deviation of a signal received by the receiver from a signal being transmitted by a transmitter. For example, the error factor may be an error vector, such as that shown in FIG. 2b, that represents the error between corrected signal 61 and decoded signal 63. As the received signal is affected by channel distortion and/or errors when passing through the transmission channel, the received signal includes information of the effects of the transmission channel. Therefore, the error factor includes information of the most recent channel characteristics.

In order to calculate the error factor, the error calculation module 612 may perform a function similar to that of decision module 610 that demodulates the frequency domain corrected signal 61, and determines a vector between the demodulated signal and the decoded signal 63. In another embodiment, the decision module 610 may calculate the error vector during generation of the decoded signal 63 from corrected signal 61. The error vector is then sent to the control module 616 directly. In that case, the error calculation module can be omitted.

The error factor 65 is fed to control module 616 which determines whether the error factor 65 meets a predetermined requirement. For example, control module 616 determines whether the error factor is lower than a predetermined threshold. The level of threshold can be set based on preference of system designs or empirically. Control module 616 may calculate the mean square error of the error factor. If the mean square error of the error factor is lower than the predetermined threshold, the channel correction is acceptable. If the channel correction is acceptable, control module 616 generates a first control signal to control channel correction calculation module 614 to continue to use the algorithm that is being used to generate the channel correction factor.

On the other hand, if the mean square error of the error factor estimate exceeds the predetermined threshold, it means that the corrected signal is distorted and the error correction is not effective. In response, control module 616 generates a second control signal to control channel correction calculation module 614 to modify the way the channel correction factor is generated, such as by using a different algorithm, modifying coefficients, and/or introducing more data into calculation of the channel correction factor. Additional data that may be used in the calculation of the channel correction factor include, but are not limited to, past error factors and/or channel correction factors, and the like. Other data that are known to people skilled in the art can also be utilized to calculate the channel correction factor without deviating from the concepts disclosed by this application.

Detailed operation of receiver 600 is described as follows. Similar to the receivers described earlier, OFDM receiver 600 calculates an initial value of the channel correction factor by using training symbols. The exact number of training symbols used to determine the initial value depends on the industrial standard and/or communication protocols used to implement the OFDM receiver. As described earlier, under the IEEE 802.11a standard, each signal frame includes two long training symbols (LTS). The LTS are known to OFDM receiver 600. Prior to receiving any signal, information related to the LTS may be pre-stored in a memory device accessible by OFDM receiver 600.

When antenna 602 receives the training symbols, RF receiver 604 recognizes the symbols as LTS. The receiver 600 may use a device that has access to the received training symbol and the known training symbol to calculate an initial value of the channel correction factor. For example, receiver 600 can include the function in equalizer 608, decision module 610, error calculation module 612, channel correction calculation module 614, or a dedicated device, such as a controller (not shown). The calculation first determines the channel distortion by comparing the received LTS and the LTS known to OFDM receiver 600 to determine the amount of error caused by the transmission channel. Once the amount of channel distortion is known, the channel correction factor is set at an initial value that can compensate for the error caused by the channel distortion. Detailed calculation of the initial value is explained as follows.

The channel response based on the training symbols can be calculated as follows:

Ĉ(k)=Ĉₖe^{j\hat{φ}}^{C}_{ₖ} k=1 . . . N

$${\hat{C}}_{k} = \frac{\vert {R}_{TS} ( k ) \vert}{\vert {I}_{TS} ( k ) \vert} \qquad {\hat{φ}}_{{C}_{k}} = {φ}_{{R}_{TS}} - {φ}_{{I}_{TS}}$$

wherein

Ĉ(k)=Estimated Channel response

R_{TS}(k)—Received training symbol

I_{TS}(k)—Actual training symbol known to receiver

k=sub-carrier index

N=Number of sub-carriers

Thus, an estimated channel response for each sub-carrier can be determined. Accordingly, an initial value of channel correction factor is set for each sub-carrier.

Noise variance can also be determined as discussed earlier:

R_{TS}(k)=S_{TS}(k)C(k)+nₓ_{₁} R_{TS}(k)=S_{TS}(k)C(k)+nₓ_{₂}

$$\begin{matrix}{R}_{TS 1} - {R}_{TS 2} = {S}_{TS 1} ( k ) C ( k ) - {S}_{TS 2} ( k ) C ( k ) + {n}_{{x}_{1}} - {n}_{{x}_{2}} \\ = {n}_{{x}_{1}} - {n}_{{x}_{2}} \\ = {\hat{n}}_{x}\end{matrix}$$

wherein

R_{TS1}(k)=Received OFDM training symbol after FFT

S_{TS}=Send OFDM training symbol after FFT

nₖ=Additive noise

Thus, the noise variance is:

$${σ}_{n}^{2} = \frac{var ( Re \{ {\hat{n}}_{k} \} ) + var ( Im \{ {\hat{n}}_{k} \} )}{4}$$

Accordingly, the initial channel correction factor for magnitude is set as:

$${H}_{k} = \frac{1}{\sqrt{{C}_{k}^{2} + {σ}_{n}^{2}}}$$

wherein Hₖ=Magnitude of channel correction

Channel correction factor to compensate for phase is \hat{φ}_{C}_{ₖ}=φ_{R}_{_{TS}}−φ_{I}_{_{TS}}.

After the initial value of the channel correction factor is determined, the initial value of the channel correction factor is written to a memory space that stores the channel correction factor and is accessible by the receiver 600. Equalizer 608 reads out the channel correction factor and applies the channel correction factor to an OFDM symbol received after the training symbols to obtain a corrected symbol \hat{R}ₖ[n]. The corrected symbol \hat{R}ₖ[n] is then passed through decision module 610 to generate a decoded symbol \tilde{R}ₖ[n]. As previously stated, decision module 610 may be a standard demodulation block that maps each corrected signal in the received symbol to its nearest constellation point.

After decision module 610 generates the decoded signal, error calculation module 612 calculates the error factor \tilde{ε}ₖ[n] as:

$${\tilde{ϵ}}_{k} [ n ] = \frac{{\tilde{R}}_{k} [ n ]}{{\hat{R}}_{k} [ n ]}$$

In order to predict a channel response, channel correction calculation module 614 may use a conversion formula to predict channel response. Examples of the conversion fomula that can be used to predict the channel response include Levinson-Durbin algorithm, Kalman, LMS, etc. Certain parameters, such as coefficients of the conversion formula, need to be calculated for the conversion formula. For example, the parameters may be coefficients used in some form of FIR filters. In the case of linear predictive coding, the coefficients can be based on a certain number of past error factors, and are calculated based on Levinson-Durbin recursive estimation. The coefficients may be calculated by using one single symbol of a frame at a time. The coefficients can then be used throughout other symbols of the frame if the statistical characteristics of the channel stay the same. The coefficients may be represented as:

αₖ[0]=f(\tilde{ε}ₖ[0])

αₖ[1]=f(\tilde{ε}ₖ[1],αₖ[0])

αₖ[2]=f(\tilde{ε}ₖ[2],αₖ[0],αₖ[1])

After the coefficients are determined, channel correction calculation module 614 uses an FIR filter to produce the predicted channel response. One example of the algorithm used in predicting channel response is as follows:

$$\hat{ϵ} [ n + 1 ] = {\sum }_{j = 0}^{P} {a}_{j} {\tilde{ϵ}}_{k} [ n - j ]$$

$${\hat{C}}_{k} [ n + 1 ] = {\hat{C}}_{k} [ n ] {\tilde{ϵ}}_{k} [ n + 1 ]$$

Channel correction calculation module 614 then updates the channel correction factor. The channel correction factor may be stored in a memory space-accessible by the equalizer 608. Whenever an updated channel correction factor is calculated, the channel correction calculation module 614 writes the updated channel correction factor to the memory space. Equalizer 608 always uses the most updated channel correction factor to correct channel errors.

Equalizer 608 then applies the updated channel correction factor to the channel response as follows when the next data symbol arrives:

$${\hat{R}}_{k} [ n ] = \frac{{R}_{n} [ n ] {ⅇ}^{( - j {\hat{φ}}_{ck} [ n ] )}}{\sqrt{{\vert {\hat{C}}_{k} [ n ] \vert}^{2} + {σ}_{n}^{2}}}$$

Receiver 600 uses control module 616 to monitor the performance of the channel correction. For each sub-carrier k, control module 616 constantly checks the mean square error between the corrected symbol 61 and decoded symbol 63, and determines if the error between the two signals exceeds a predetermined requirement. In one example, the control module determines if the mean square error of the error factor exceeds a predetermined threshold δ:

Eₙ{(\hat{ε}ₖ[n]−\tilde{ε}ₖ[n])²}>δ

wherein δ is set based on preference of system design or may be set empirically. If the mean square error of the error factor is lower than a predetermined threshold, control module 616 determines that the channel correction is effective and no adjustments are performed.

On the other hand, if the mean square error exceeds the predetermined threshold, then control module 616 determines that the channel correction is ineffective and generates a control signal 67 to notify channel correction calculation module 614 to modify the way the channel correction factor is generated.

In order to modify the way the channel correction factor is generated, according to one embodiment, channel correction calculation module 614 recalculates the tracking coefficients, and/or selectively increases or decreases the number of coefficients used in the prediction. For example, channel correction calculation module 614 may use an algorithm that uses a minimum amount of coefficients and continuously increases the number of coefficients until the mean square error of the error factor is again lower than the predetermined threshold.

According to another embodiment, channel correction calculation module 614 simply changes the algorithm used in predicting the channel response. For example, LMS (least mean squares) may be upgraded to RLS (recursive least squares).

As discussed earlier, under IEEE 802.11a, each symbol includes 52 sub-carrier signals. Channel correction calculation module 614 may apply the same algorithm to all sub-carrier signals, or apply different algorithms to different sub-carrier signals based on the transmission qualities. The transmission qualities can be determined based on information related to the error factor estimate, such as mean square error of the error factor and the error factor estimate.

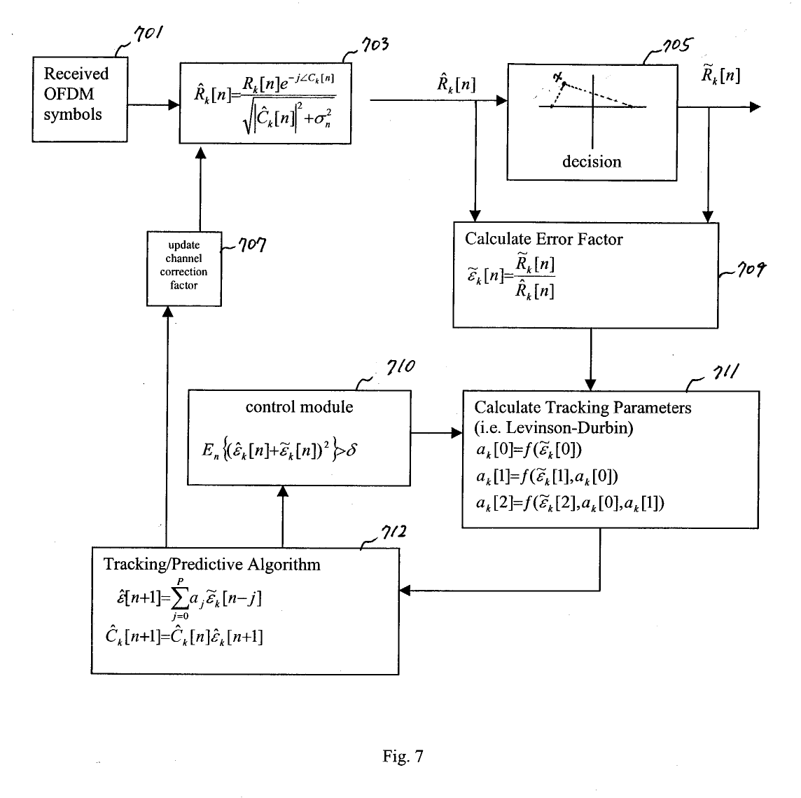

FIG. 7 is a flow chart showing the operation of OFDM receiver 600 as shown in FIG. 6. The steps for determining the initial value of the channel correction factor is similar to those described above regarding receiver 300. For simplicity of illustration, descriptions related to those steps are omitted.

In step 701, OFDM symbols are received and converted to the frequency domain. Equalizer 608 applies the channel correction factor to the symbol to generate a corrected symbol (step 703). The corrected symbol is then passed through decision module 610 which generates a decoded symbol (step 705). Error calculation module 612 then calculates the error factor based on the corrected symbol and the decoded symbol (step 709). Channel correction calculation module 614 calculates the tracking parameters, generates a channel correction factor, and updates the channel correction factor (steps 711, 712 and 707).

In step 710, control module 616 determines whether the mean square error of the error factor estimate exceeds a predetermined threshold and controls the operation of channel correction calculation module 614 based on the result of the determination (step 710). If the mean square error of the error factor does not exceed the predetermined level, control module 616 controls the error correction module to maintain the way the channel correction factor is generated. On the other hand, if control module 616 determines that the mean square error of the error factor estimate exceeds the predetermined level, control module 616 controls channel correction calculation module to change the way the channel correction calculation module 614 generates the channel correction factor as discussed earlier.

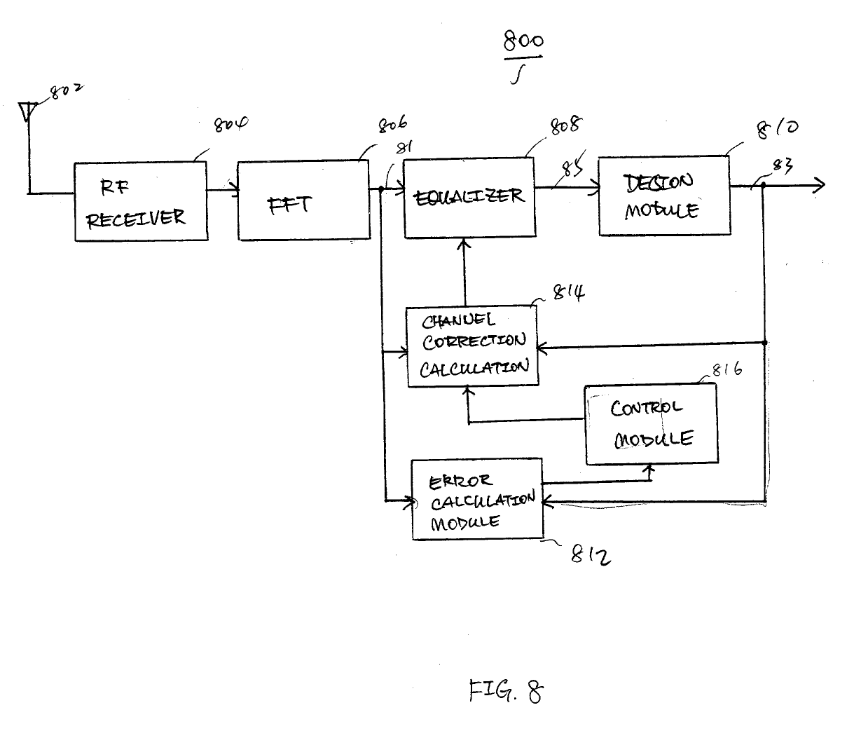

FIG. 8 shows another embodiment of OFDM receiver. OFDM 800 includes antenna 802, RF receiver 804, FFT module 806, equalizer 808, decision module 810, error calculation module 812, control module 814 and channel correction calculation module 812. In FIG. 8, error calculation module 812 receives inputs from FFT module 806 and decision module 810. Thus, error calculation module 812 calculates an error factor that represents an amount of error between uncorrected signal 81 and decoded signal 83, instead of an error between the corrected signal and the decoded signal.

The calculation of the error factor can be carried out as that discussed with respect to receiver 300 or receiver 600. Based on the error factor, error calculation module 812 is able to determine the error between the uncorrected signal 81 and the decoded signal 83, which represents the amount of distortion caused by the transmission channel. Based on this information, control module 816 generates a control signal to control the way channel correction calculation module 814 generates the channel correction factor as discussed above.

The other functional blocks of OFDM receiver 800 are substantially the same as those of OFDM receiver 600. It will be apparent to one skilled in the art to apply the same concepts described relating to receiver 600 without specific details.

Other variations of the predictive receiver 800 are available. For example, while error calculation module 812 may calculate an error factor based on uncorrected signal 81 and decoded signal 83, if preferred, channel correction calculation module 814 may calculate a channel correction factor based on corrected signal 85 and decoded signal 83. On the other hand, if preferred, error calculation module 812 may calculate an error factor based on corrected signal 85 and decoded signal 83, and channel correction calculation module 814 may calculate a channel correction factor based on corrected signal 81 and decoded signal 83.

For adaptive or predictive receivers as described above, the equalizer does not have to apply the channel correction factor to every incoming symbol or signal. The equalizer can control the application of the channel correction factor at different frequencies. For example, the equalizer may apply the channel correction factor on every incoming symbol. If preferred, the equalizer may apply the channel correction factor to every other symbol or other frequencies depending on system design.

The selection of correction frequency may depend on the quality of the transmission channel. If the quality of the transmission channel is good and stable, frequent error correction is not necessary. The equalizer may apply the channel correction factor less frequently. On the other hand, if it is determined that the transmission quality varies, frequent correction may be necessary. The transmission quality may be determined based on the error factor. If the mean square error of the error factor is smaller than a predetermined threshold, the equalizer increases the frequency of correction. Otherwise, the equalizer may maintain or decrease the frequency of correction.

### System Application of Adaptive Channel Correction

The adaptive channel correction described earlier can be used in various communication systems and/or protocols to improve performance on a system level. For example, the techniques can be used in a system complying with a multi-layer, network communication standard, such as IEEE 802.11a standard. IEEE 802.11a is an OFDM wireless networks protocol employing a multi-layer structure where different aspects of networking rules are handled by different groups, or layers, of instructions.

The 802.11a framework defines the lowest two layers of the Open Systems Interconnection (OSI) reference model for networks. The physical layer (PHY) is the lowest of all layers, and describes the medium handling the transmission (e.g. wireless channel) and the physical signaling protocol required for putting data onto the medium (e.g. modulation, error correction, etc.). The next higher layer is the medium access control (MAC) layer, which describes the rules for accessing the physical layer (e.g. associate, power-management, and data-distribution).

The adaptive channel correction described earlier can be embodied as part of a wireless network system to provide feedback information about the transmission channel. The feedback information enables enhanced performance beyond the advantages of increased mobility and throughput mentioned previously. Information related to the error factors for sub-carrier signals or symbols is sent to a system controller that controls the operation of the network system. The system controller determines the channel performance based on error factors resulting from channel distortions. If the transmission quality of a sub-carrier signal or sub-carrier signals is degrading and thus the error factor thereof exceeds a predetermined threshold, the system controller may send a control signal to stop transmitting signals on that specific sub-carrier. As this operation affects only lower level transmission settings, it is not necessary to adopt higher level adjustment, such as scheduling or increasing transmission power, which increases cost and complexity.

The adaptive channel correction can also be used to improve immunity to jamming in wireless networks. As discussed earlier, wireless networks, such as IEEE 802.11a networks, encounter problems from an intentional (e.g. denial of service attack) of unintentional (e.g. hidden node) jammer. Information related to the quality of transmission channels, such as the error factor, is provided to the system control to configure the system operation. In response to the channel quality information, the communication system may make MAC layer (e.g. routing) or PHY layer (e.g. modulation) decisions in an adaptive fashion.

For example, if the adaptive channel correction determines that narrowband interference is affecting a set of sub-carriers, this information can be sent to the system controller. In response, the system controller controls the system to ignore these sub-carriers and/or reroute signal packets upon subsequent transmit and receive sequences. This approach is independent of the jammer's energy, and allows for asynchronous operation, thereby increasing the data throughput.

The same technique can also be used in resource allocation. In a multiple carrier communication system, such as an OFDM-based system, user's bandwidth requirement may only require a subset of the carriers within a channel to transmit signals. In this case, the carriers used in transmitting signals can be selected based on information related to their respective transmission channel qualities, which can be determined based on the error factors obtained during adaptive channel correction as discussed above. Optimum transmission quality can be achieved by transmitting signals using carriers with better transmission quality.

Furthermore, information related to channel transmission quality, such as the error factor obtained during adaptive channel correction as discussed above, provides a breakdown analysis of each sub-carrier signal. Therefore, a system administrator can make adjustments to the communication system based on separate performance of each carrier rather than based on an overall signal strength of the signals.

Adaptive channel correction can also be used to improve performance of smart antenna systems. Smart antenna systems is used to reduce multi-path fading in wireless transmissions. A smart antenna system combines multiple antenna elements (i.e. antenna array) with a signal processing capability to optimize its radiation and/or reception pattern automatically in response to the signal environment.

One type of smart antenna systems is a beamforming antenna system. A beamforming antenna system uses several antennas, each of the antennas can be excited with a different amplitude and phase to electrically “steer” the antenna. In smart beamforming systems, the amplitudes and phase of each antenna are altered to find the best configuration, which offers the best average signal strength of the received signal. Feedback is provided by a receive signal strength indicator (RSSI) in a receiver, and is taken from an automatic gain control (AGC) circuit, to provide an estimate of the average signal power at the receiver. However, received signal strength obtained through these means does not reduce errors caused by deep narrow fades in OFDM spectrums, as deep fade may still cause errors even though the overall signal strength appears to be acceptable.

The adaptive channel correction described earlier can improve a beamforming system by providing the necessary feedback signal to optimize the signal to noise ratio (SNR) across all OFDM sub-carriers. At the beginning of each frame, the adaptive receiver calculates the average noise level in order to set limits for the channel correction. At the same time, the received signal strength is determined from the training symbols for use in the demodulation of other symbols. Accordingly, an estimate of the signal to noise ratio (SNR) can be determined. The SNR can be used as the error factor in a beamforming loop. Since the adaptive receiver provides feedback on a symbol by symbol basis, the system can alter the weights of each antenna until the SNR is maximized for all or some of the OFDM sub-carriers to increase transmission range and reduce interference.

The disclosure has been described with reference to specific embodiments thereof. It will, however, be evident that various modifications and changes may be made thereto without departing from the broader spirit and scope of the disclosure. It should be noted that the recitation of IEEE 802.11 standard families is for illustration purpose only. The concepts described in the disclosure can apply to various technical standards without departing from the concepts. The specification and drawings are, accordingly, to be regarded in an illustrative rather than a restrictive sense.

What is claimed is:

1. A method for adaptive channel correction in a receiver that receives a series of signals transmitted by a transmitter, comprising the steps of:
(a) calculating an error factor representing a deviation of one of the series of signals transmitted by the transmitter;
(b) calculating a channel correction factor based on the error factor;
(c) applying the channel correction factor to a signal received after the signal from which the error factor is calculated;
(d) repeating step (a) through step (d).

2. The method of claim 1, wherein the channel correction factor has an initial value obtained by the steps of:
calculating an initial value of the error factor based on at least one transmitted reference signal and at least one known reference signal; and
calculating the initial value of the error correction factor based on the initial value of the error factor.

3. The method of claim 1, wherein step (d) repeats step (c) only when the error factor fails to meet a specific requirement.

4. The method of claim 2, wherein the specific requirement requires the error factor to be lower than a specific threshold.

5. A system for processing a series of signals transmitted by a transmitter comprising:
an equalizer adjustment module for calculating an error factor for each of a plurality of the signals transmitted by the transmitter, and for calculating a plurality of channel correction factors, each of the plurality of channel correction factors being calculated based on one of the error factors for the plurality of signals transmitted by the transmitter, wherein the error factor represents a deviation from one of the series of signals transmitted by the transmitter; and
an equalizer for applying one of the plurality of channel correction factors to a signal that is received after the signal from which the one of the plurality of channel correction factors is generated.

6. The system of claim 5, wherein the channel correction factor has an initial value obtained by the steps of:
receiving at least one transmitted reference signal; and
calculating the initial value of the error correction factor based on the at least one transmitted reference signal and at least one known reference signal corresponding to the at least one transmitted reference signal.

7. The system of claim 5, wherein the equalizer applies one of the plurality of channel correction factors to the signal that is received after the signal from which the one of the plurality of channel correction factors is generated only when one error factor for the plurality of the signals transmitted by the transmitter fails to meet a specific requirement.

8. The system of claim 7, wherein the specific requirement requires that the error factor does not exceed a specific threshold.

9. A system for correcting channel distortion comprising:
an equalizer adjustment module for updating a channel correction factor;
an equalizer for applying the channel correction factor to a first signal to generate a first corrected signal;
a decision module for generating a first decoded signal based on the first corrected signal;
wherein the equalizer adjustment module is configured to update the channel correction factor based on the first corrected signal and the first decoded signal, or based on the first signal and the first decoded signal, and apply the channel correction factor to a second signal.

10. The system of claim 9, wherein
the equalizer is configured to generate a second corrected signal by applying the channel correction factor updated by the equalizer to the second signal;
the decision module is configured to generate a second decoded signal based on the second corrected signal; and
the equalizer adjustment module is configured to update the channel correction factor based on the second corrected signal and the second decoded signal, or based on the second signal and the second decoded signal.

11. The system of claim 9, wherein the channel correction factor has an initial value obtained by the steps of:
receiving at least one transmitted reference signal; and
calculating the initial value of the error correction factor based on the at least one transmitted reference signal and at least one known reference signal corresponding to the at least one transmitted reference signal.

12. A method for adaptive channel correction comprising the steps of:
(a) applying a channel correction factor to a received signal to generate a corrected signal;
(b) calculating a decoded signal based on the corrected signal;
(c) updating the channel correction factor based on the decoded signal and the corrected signal, or based on the received signal and the decoded signal;
(d) receiving another signal; and
(e) repeating step (a) through step (e).

13. The method of claim 12, wherein the channel correction factor has an initial value obtained by the steps of:
receiving at least one transmitted reference signal; and
calculating the initial value of the error correction factor based on the transmitted reference signal and at least one known reference signal corresponding to the at least one transmitted reference signal.

14. A method for dynamic correction of channel distortion comprising the steps of:
(a) applying a channel correction factor to a received signal to generate a corrected signal;
(b) calculating a decoded signal based on the corrected signal;
(c) determining an error factor based on the received signal and the decoded signal, or based on the corrected signal and the decoded signal;
(d) calculating a channel correction factor based on the received signal, the corrected signal and a conversion formula, or based on the decoded signal, the corrected signal and the conversion formula, wherein the conversion formula is set to be a first formula;
(e) monitoring the error factor; and
(f) setting the conversion formula to a second formula in response to the error factor exceeding a predetermined threshold.

15. The method of claim 14 further comprising the steps of:
(g) updating the channel correction factor based on the corrected signal, the decoded signal and the second formula, or based on the received signal, the decoded signal and the second formula;
(h) receiving another signal; and
(i) repeating step (a) through step (i).

16. A system for processing a signal comprising:
an equalizer for applying a channel correction factor to the signal to generate a corrected signal;
a decision module for decoding the corrected signal to generate a decoded signal;
an error calculation module for calculating an error factor based on the corrected signal and the decoded signal;
a channel correction calculation module for generating the channel correction factor based on the corrected signal, the decoded signal and a conversion formula, or based on the signal, the decoded signal and the conversion formula; and
a control module for modifying the conversion formula in response to the error factor exceeding a predetermined threshold.

17. The system of claim 16, wherein the channel correction calculation module updates the channel correction factor based on the corrected signal, the decoded signal and the second formula, or based on the signal, the decoded signal and the second formula.

18. The system of claim 17, wherein the equalizer applies the channel correction factor that is updated by the channel correction calculation module to the next signal received by the receiver.

19. A method for correcting channel distortion comprising the steps of:
(a) applying a channel correction factor to a received signal to generate a corrected signal;
(b) calculating a decoded signal based on the corrected signal;
(c) determining an error factor based on the received signal and the decoded signal, or based on the corrected signal and the decoded signal;
(d) calculating the channel correction factor based on the received signal, the corrected signal and a conversion formula, or based on the decoded signal, the corrected signal and the conversion formula;
(e) monitoring the error factor;
(f) introducing more data into the conversion formula in generating the error correction factor in response to the error factor failing to meet a predetermined requirement;
(g) updating the channel correction factor;
(h) receiving another signal; and
(i) repeating step (a) through step (i).

20. A system for processing a series of signals transmitted by a transmitter comprising:
an error calculation module for calculating an error factor for each of a plurality of the signals transmitted by the transmitter, wherein the error factor represents a deviation from one of the series of signals transmitted by the transmitter;
a channel correction calculation module for generating a plurality of channel correction factors, each of the plurality of channel correction factors being calculated based on a conversion formula and one of the error factors for the plurality of signals transmitted by the transmitter;
an equalizer for applying one of the plurality of channel correction factors to a signal that is received after the signal from which the one of the plurality of channel correction factors is generated; and
a control module, responsive to the one of the error factors for the plurality of signals transmitted by the transmitter exceeding a predetermined threshold, for modifying the conversion formula in generating the channel correction factor for.

21. The system of claim 20, wherein the channel correction factor has an initial value obtained by the steps of:
receiving at least one transmitted reference signal; and
calculating the initial value of the error correction factor based on the at least one transmitted reference signal and at least one known reference signal corresponding to the at least one transmitted reference signal.

22. An adaptive method for correcting channel distortion comprising the steps of:
(a) applying a channel correction factor to a received signal to generate a corrected signal;
(b) calculating a decoded signal based on the corrected signal;
(c) determining an error factor based on the received signal and the decoded signal, or based on the corrected signal and the decoded signal;
(d) using a first method to calculate the channel correction factor based on the received signal and the corrected signal, or based on the decoded signal and the corrected signal;
(e) monitoring the error factor;
(f) using a second method to calculate the channel correction factor based on the received signal and the corrected signal, or based on the decoded signal and the corrected signal;
(g) updating the channel correction factor;
(h) receiving another signal; and
(i) repeating step (a) through step (i).

23. An adaptive method for correcting channel distortion in a receiver that receives a signal transmitted by a transmitter, the method comprising the steps of:
(a) calculating an error factor representing a deviation from the signal transmitted by the transmitter;
(b) using a formula to calculate a channel correction factor based on the error factor;
(c) monitoring the error factor; and
(d) responsive to the error factor exceeding a predetermined threshold, modifying the formula used in step (b).

24. The method of claim 23 further including a step (e) of repeating step (a) through step (e).

25. A system for processing a signal transmitted by a transmitter comprising:
an error calculation module for calculating an error factor representing a deviation from the signal transmitted by the transmitter;
a channel correction calculation module for generating a channel correction factor based on the error factor and a conversion formula;
an equalizer for applying the channel correction factor to signals received by the receiver; and
a control module for modifying the conversion formula in response to the error factor exceeding a predetermined threshold.

26. A communication system comprising:
a receiver for receiving a signal transmitted by a transmitter using a sub-carrier;
an error factor calculation module for calculating an error factor representing a deviation from the signal transmitted by the transmitter using the sub-carrier; and
a controller, responsive to the error factor failing to meet a specific requirement, reconfiguring settings of the communication system.

27. The communication system of claim 26, wherein the requirement requires that the error factor does not exceed a predetermine threshold.

28. The communication system of claim 26, wherein the controller reconfigures the settings of the communication system to stop using the sub-carrier to transmit signals.

29. The communication of claim 26, wherein the controller provides information related to the error factor.

30. A communication system for processing a plurality of signals transmitted by a transmitter using a plurality of sub-carriers, comprising:
an error factor calculation module for calculating an error factor for each of the plurality of signals, wherein the error factor represents a deviation from one of the plurality of signals transmitted by the transmitter using the sub-carriers; and
a controller configured to perform the steps of:
determining transmission quality for each of the plurality of sub-carriers based on whether their respective error factor meeting a specific requirement; and
identifying sub-carriers that have corresponding error factors meeting the specific requirement.

31. The system of claim 30, wherein the controller further sends information related to the sub-carriers that have corresponding error factors meeting the specific requirement to the transmitter.

32. The system of claim 30, wherein the controller further controls the transmitter to use the sub-carriers that have corresponding error factors meeting the specific requirement to transmit signals.

33. A method for processing a plurality of signals transmitted by a transmitter using a plurality of sub-carriers, comprising:
calculating an error factor for each of the plurality of signals, wherein the error factor represents a deviation from one of the plurality of signals transmitted by the transmitter using the sub-carriers;
determining transmission quality for each of the plurality of sub-carriers based on whether their respective error factor meeting a specific requirement; and
identifying sub-carriers that have corresponding error factors meeting the specific requirement.

34. The method of claim 33 further comprising a step of controlling the transmitter to use the sub-carriers that have corresponding error factors meeting the specific requirement to transmit signals.

35. A method for controlling a communication system having a plurality of antenna elements, wherein each of the plurality of antenna elements receives a plurality of signals, the method comprising the steps of:
calculating an error factor for each of the plurality of signals received from each of the plurality of antenna elements, wherein the error factor represents a deviation from one of the plurality of signals transmitted by the transmitter using the sub-carriers;
determining transmission quality for each of the plurality of signals received from each of the plurality of antenna elements based on whether their respective error factor meeting a specific requirement;
for each of the plurality of signals, identifying at least one of the plurality of antenna elements that has a corresponding error factor meeting the specific requirement;
for each of the plurality of signals, assigning a weight to each of the plurality of antenna elements based on a result of the identifying step; and
for each of the plurality of signals, generating a corrected signal based on the weight assigned to each of the plurality of antenna elements.

36. The method of claim 35, wherein the plurality of signals are transmitted using a plurality of sub-carriers.
